(19) United States
(12) Patent Application Publication
(10) Pub. No.: US 2025/0377331 A1
(43) Pub. Date: Dec. 11, 2025

(54) METHOD FOR MANUFACTURING AN ELECTRICAL COMPONENT BY MEANS OF SUCCESSIVE PRINTING AND SINTERING OF PARTICLE-CONTAINING INK

(71) Applicant: UNIVERSITÄT STUTTGART, Stuttgart (DE)

(72) Inventors: Pascal GRÖGER, Stuttgart (DE); Stefanos FASOULAS, Neckartenzlingen (DE)

(73) Assignee: UNIVERSITÄT STUTTGART, Stuttgart (DE)

(21) Appl. No.: 18/879,076

(22) PCT Filed: Jun. 20, 2023
(86) PCT No.: PCT/EP2023/066648

§ 371 Date: Dec. 26, 2024

(30) Foreign Application Priority Data
Jun. 27, 2022 (DE) 10 2022 115 912.4

(51) Int. Cl. G01N 27/407

(52) U.S. Cl. CPC G01N 27/4073; G01N 27/4075

(57) ABSTRACT

A method for manufacturing an electrical component includes providing a substrate, printing a first layer of an ink onto the substrate, the ink including a flowable binder and a plurality of particles of a metallic, metal oxide and/or ceramic material embedded in the binder, sintering the substrate including the first layer of ink at a temperature above 300° C., for a time in a range of 1 min to 1 h, printing a further layer of an ink onto the substrate, the ink having a flowable binder and a plurality of particles of a metallic and/or ceramic material embedded in the binder, sintering the substrate including the further layer of ink at a temperature above 300° C. for a time in a range from 1 min to 1 h. The steps are repeated as necessary.

### FIELD OF THE INVENTION

The present invention relates to a method for manufacturing an electrical component, in particular a sensor, such as e.g. a gas sensor, or a solid oxide fuel cell. The invention furthermore relates to an electrical component as may be produced with the method.

### BACKGROUND OF THE INVENTION

Electrical components may be used for a very wide range of purposes. A functionality of such components may be influenced in particular by their structural form and the properties of the materials used. For example, electrical components may be composed of a multiplicity of different layers. Each of these layers may be selected or adapted especially for the purpose of the electrical component in terms of its structural properties such as, for example, its layer thickness, its contour, its homogeneity, its porosity, its surface properties, etc. and in terms of its typical material properties such as, for example, its electrical properties (in particular conductivity), thermal properties (in particular coefficient of expansion), mechanical properties, etc.

For example, gas sensors are known in the case of which electrodes are arranged on a layer with solid electrolytic properties. The electrodes may be, for example, metallic or metal oxide. An electric voltage may be applied via the electrodes to the solid electrolytic layers contacted by them. The solid electrolytic layer may be constructed with ceramic and/or metal oxide material. As a result of the applied electric voltage, free ions may move in the solid electrolytic layer in particular if the solid electrolytic layer is heated to elevated temperatures of, for example, above 400° C. A concentration of free ions may be dependent in this case on ambient conditions. Such ambient conditions generally include in particular gases which come into contact with the layer. The ambient conditions, in particular ambient gases and their concentrations, may correspondingly be deduced by measuring an electric current which flows as a result of the electric voltage applied to the layer.

Moreover, solid oxide fuel cells (SOFC) are known, in the case of which, inter alia, a layer composed of an electrolyte present as a solid body is arranged between electrodes.

Various manufacturing methods were developed in order to be able to manufacture electrical components constructed from layers of various materials. For example, layers may be applied on a substrate by Physical Vapor Deposition (PVD) and/or Chemical Vapor Deposition (CVD). Alternatively, layers may be applied onto the substrate by printing techniques such as, for example, screen printing. Technologies conventionally used to apply the layers, however, require usually complex and/or expensive devices to separate the layers. Moreover, both Physical Vapor Deposition techniques and printing techniques are furthermore usually configured to provide surfaces with a layer over the full surface so that in the event that only parts of a surface are supposed to be coated, i.e. that a layer with a pattern or a contour should be applied, additional measures such as, for example, the use of masks, templates, etc. must be performed. Additional outlay and costs regularly arise as a result of this. Moreover, in addition to the partial surfaces which are actually supposed to be coated, adjacent partial surfaces covered by the mask or template are also printed so that a significant additional consumption of printed material arises.

### SUMMARY OF THE INVENTION AND OF ADVANTAGEOUS EMBODIMENTS

It was thus recognized that there may be a need for an improved method for manufacturing an electrical component as well as an electrical component which may be produced as a result of this. In particular, it should be possible to manufacture the component with low material outlay, with low equipment outlay, in a short time, with high reliability, with high energy efficiency, with high flexibility of the manufacturing process and/or with comparatively low costs.

Such a need may be met with the subject matter of one of the independent claims. Advantageous embodiments are explained in the dependent claims and in the following description and illustrated in the figures.

According to a first aspect of the invention, a method for manufacturing an electrical component is presented. The method has at least the following steps, preferably in the specified sequence:
(a) providing a substrate,
(b) printing a first layer of an ink onto the substrate, the ink comprising a flowable binder and a plurality of particles of a metallic, metal oxide and/or ceramic material embedded in the binder,
(c) sintering the substrate including the first layer of ink at a temperature above 300° C. for a time in a range of 1 min to 1 h,
(d) printing a further layer of an ink onto the substrate, the ink comprising a flowable binder and a plurality of particles of a metallic and/or ceramic material embedded in the binder,
(e) sintering the substrate including the further layer of ink at a temperature above 300° C. for a time in a range from 1 min to 1 h, wherein the steps (d) and (e) are repeated with several repetitions.

According to a second aspect of the invention, an electrical component, in particular a sensor or solid oxide fuel cell, is presented. The component comprises a substrate and a plurality of layers of a metallic, metal oxide and/or ceramic material applied to the substrate. Each of the layers is formed by printing an ink comprising a flowable binder and a plurality of particles of a metallic, metal oxide and/or ceramic material embedded in the binder, and subsequently sintering the ink at above 300° C.

Possible features and advantages of embodiments of the invention may be regarded inter alia and without restricting the invention as being based on ideas and findings described below.

In short and without restricting the invention in any manner, one fundamental principle of the manufacturing method presented here may be seen in the fact that full-surface and/or structured layers are printed onto a substrate with the aid of inkjet techniques and the layers are solidified in a suitable manner by sintering in order to give them structural and functional properties. One or more inks used in this case contain, in addition to a binder, a powder with particles of metallic, metal oxide and/or ceramic material. The ink is printed in each case in a thin layer and subsequently subjected to a sintering process. The sintering process is especially adapted to solidify the ink and sinter the particles contained therein into a layer. Therein, sintering parameters are selected so that the sintering process may be comparatively short and nevertheless desired properties of the sintered layers may be generated. In particular, it was identified that, due to the fact that several layers are printed successively and each individual layer is solidified in a short, sufficiently hot sintering step before a subsequent layer is printed, overall a layer stack with desired structural and functional properties for the formation of an electrical component may be generated. The combination of the formation of layers by inkjet printing, on one hand, and short, hot sintering steps of each individual layer, on the other hand, enables in this case high efficiency in terms of material use, energy to be used, equipment required, short duration of the manufacturing process, etc. The use of inkjet printing furthermore makes it possible to easily manufacture structured layers with different contours, as a result of which the described manufacturing method may be adapted flexibly and quickly for the production of various electrical components.

Possible details and advantages of configurations of the described method are indicated below.

The method presented herein for producing an electrical component thus generally begins in providing a suitable substrate. The substrate is generally two-dimensional, i.e. disc-shaped. In particular, the substrate may be a type of wafer. The substrate may have lateral dimensions in the range of more than 1 mm, preferably more than several millimeters, more than 1 cm or even more than several centimeters up to several decimeters or even several meters. A thickness of the substrate may be smaller than 1 cm, preferably smaller than 3 mm, smaller than 1 mm or even smaller than 0.5 mm. The substrate may provide the entire electrical component with a majority of its mechanical strength. The substrate may be self-supporting.

The substrate should consist of a material which may withstand high temperatures, in particular temperatures above 300° C., above 500° C., above 600° C. or even above 800° C. without damage. The use of a temperature-resistant material for the substrate makes it possible that sintering with comparatively high temperatures may be performed in successive process steps.

In contrast to this, when manufacturing electrical components, substrates are conventionally used which are based on plastics, in particular polymers, are low-cost and/or are bendable in a desired manner for some applications, but typically only have a low temperature resistance, i.e. for example, should be heated to no higher than 200° C., often no higher than 150° C. or 100° C., since they otherwise may undergo permanent damage, in particular permanent deformation.

According to one embodiment, the substrate may consist of an inorganic material. In particular, the substrate may consist of a ceramic material or a semi-conductor material. For example, the substrate may consist of aluminum oxide (Al2O3), aluminum nitride (AlN), zirconium oxide (ZrO2), silicon carbide (SiC), silicon nitride (Si3N4), aluminum titanate (Al2TiO5) or also aluminum silicates, aluminum oxide-silicon oxide compositions and/or silicon. Such materials are typically highly temperature-resistant. Moreover, they may have e.g. low coefficients of expansion and/or high temperature-change resistance and thus be highly suited to use at high temperatures.

According to one embodiment, the substrate may consist of an electrically insulating material. The use of an electrically insulating material may be advantageous for functionalities of the electrical component to be formed. In particular, the substrate may serve as electrical insulation between adjoining electrically conductive layers.

Firstly, a first layer and then further layers of an ink are subsequently printed onto the substrate.

The ink is adapted in terms of its composition and rheology, in particular in terms of its flowability and viscosity to be printed with the aid of inkjet printing techniques onto a surface of the substrate. Here, tiny droplets which typically have a volume in the range of picoliters (often in a volume range from 0.1 pL to 30 pL, preferably 0.5 pL to 5 pL), are sprayed from a printhead in a direction of the surface to be printed. The droplets may be printed very closely adjacent to one another or even overlapping one another. As a result of this, the surface to be printed may be wetted at least in partial regions over a full surface with ink. The entire surface may ultimately be covered with a layer of ink. Alternatively, only partial regions of the surface may be covered with a layer of ink and contoured or patterned layer regions of ink may be generated which are adapted for a generation of desired functionalities in the electrical component.

The ink generally comprises a flowable binder. For example, glycol ether (e.g. triethylene glycol (TGME)), alcohols (e.g. ethanol, methanol, ethylene glycol), terpineol, dimethylformamide (DMF), diethanolamine (DEA or DEOA), dimethyl sulfoxide (DMSO), water, cyclohexanon may be used as the binder. Particles of a metallic, metal oxide and/or ceramic material are embedded into the binder. A volume proportion of the particles in the ink may lie within a large range from less than 1 wt.-% to 70 wt.-% or even higher, for example, in a range from 1 wt.-% to 70 wt.-%, preferably in a range from 2 wt.-% to 50 wt.-%.

In order to be able to form, for example, an electrically conducting layer with the aid of the ink, the ink may have metallic or metal oxide particles. For example, the particles may comprise metals such as platinum (Pt), gold (Au), copper (Cu), silver (Ag), nickel (Ni), palladium (Pd), tin (Sn) or mixture or alloys thereof. In particular, it may be advantageous for the functionality of the component to be formed to use noble metal particles. The metals may also be present as metal oxides. Metal oxides have different properties to pure metals or their mixtures or alloys. Metal oxides are thus used in metal oxide sensors e.g. n-type semi-conductor sensors or e.g. also in (field effect) transistors. Materials for this purpose are then e.g. zinc oxide (ZnO), tungsten oxide (WO3), aluminum-doped zinc oxide (AZO), palladium oxide (PdO), nickel oxide (NiO), tin oxide (SnO2), titanium oxide (TiO2), ceroxide (CeO2), copper oxide (CuO), indium tin oxide (ITO).

In order to be able to form, for example, an electrically insulating layer, in particular a layer which acts as a solid body electrolyte, or special types of electrodes (e.g. for fuel cells) with the aid of the ink, the ink may have ceramic particles. For example, the particles may comprise yttrium oxide-stabilized zirconium oxide (YSZ). Alternatively, the particles may comprise lanthanum strontium cobalt ferrite (LSCF), lanthanum strontium gallium magnesium oxide (LGSM), lanthanum strontium ferrite (LSF), gallium-doped ceroxide (GDC) or further types of perovskite.

According to one embodiment, the particles in the ink should be nano-particles. Such nanoparticles typically have dimensions in the region of nanometers, i.e. in the sub-micrometer range. As a result of their small size, a large number of tiny particles may therefore be contained in small droplets as are sprayed in the case of inkjet printing. As a result of this, a desired rheology of the ink is enabled. The ink may also be referred to as a nano-particle suspension.

According to one embodiment, the ink and thus the layers formed hereby are printed in such a manner that the layer has a layer thickness of between 5 μm and 60 μm, preferably between 10 μm and 30 μm after printing and prior to the subsequent sintering. By printing such thin layers, the properties of an entire layer formed in total by the several layers are influenced in a desired manner. In particular, the individual layers may be thin in such a manner that they do not flow laterally or in any event not substantially after printing. As a result of this, layers with a desired lateral contour may be printed precisely. Moreover, the individual layers may be thin in such a manner that binders escape from them rapidly and without any problems.

It should be pointed out in this context that the layer thickness which arises during or after printing may also be influenced by further factors in addition to the volume of the applied ink. For example, a porosity or a absorption of the substrate to be printed may influence how much ink is absorbed in the substrate and thus does not form part of the layer above it. The layer thickness may in this case be understood as that thickness of the layer which remains above the surface of the substrate if the substrate is already saturated with ink absorbed therein. Moreover, as a result of surface tensions, the ink may have an arched outer surface, wherein in this case the layer thickness may be understood as a maximum thickness of the layer. The volume proportion of the particles absorbed in the ink may also vary greatly, for example, between a few percent and up to 70 vol-% and may influence the required layer thickness of ink.

After each printing of a layer, the printed layer is subjected to a sintering process before a next layer is potentially printed.

The sintering is performed in this case at a temperature of more than 300° C. Preferably, after printing at least one of the several layers, the sintering process is performed at a temperature of more than 500° C. or even a temperature of 600° C. or more. In particular, it may be advantageous to perform the subsequent sintering process at more than 500° C. or even at least 600° C. at least after the printing of the last of the several steps. In other words, it is considered to be advantageous to subject each of the printed layers at least once to sintering at at least 500° C., preferably at least 600° C. Each of the sintering processes is preferably performed after the printing of each layer at at least 500° C., preferably at least 600° C.

The sintering process may be performed comparatively quickly and is therefore referred to herein partially also as a rapid sintering process. In particular, the sintering may last longer than 1 min, but less than 1 h. The time of the sintering is in the case of at least one of the sintering steps, preferably in the case of all the sintering steps, less than 20 min, preferably less than 15 min or even less than 10 min. In contrast to this, in the case of conventional thermal sintering, sintering is usually performed over very long periods of time of several hours in order to obtain a layer with a high density.

It was observed that, particularly in the case of the desired high sintering temperatures, comparatively short sintering may be adequate in order to provide the printed and then sintered layer with a desired functionality, in particular desired electrical properties such as, for example, a desired ion conductivity or electrical conductivity, as is desired for the formation of an electrical component to be manufactured. As a result of the short duration of each individual sintering step, the entire component may be built up with several printed layers within a short period of time, in particular within a few hours.

In order to sinter the respectively printed layer, according to one embodiment, the substrate may be put into a furnace preheated to at least 300° C., preferably at least 500° C. or at least 600° C. immediately after the printing of the respective layer, in particular without preceding drying and/or compression of the printed layer. In other words, in contrast to conventional methods in which an applied layer must first be dried and/or compressed prior to sintering in order to avoid damage to the layer during sintering, such additional process steps may be dispensed with.

Conventionally applied layers are often generated with a significant thickness and thus a significant proportion of binder in order thus to be able to generate a layer structure with a high thickness in a single step. In order to avoid the binder damaging the layer during sintering, this must usually first be evaporated in a drying process and/or the layer must be compressed. In the case of the method presented here, layer structures are composed of individual, very thin layers and each of these thin layers is individually sintered. Since only a small amount of binder is present in each of the layers and this may escape via a comparatively large surface, each layer may be sintered without preceding drying and/or compression. The substrate may correspondingly be put in a preheated furnace directly after the printing of the respective layer. There may thus be a few minutes, for example, less than 10 min, less than 5 min or even less than 2 min, between the printing and the sintering. As a result of this, significant time and outlay may be saved.

According to one embodiment, the sintering may be performed without the substrate being surrounded by a protective gas atmosphere. Additionally or alternatively, the sintering may be performed without an electric voltage being applied to the substrate.

Alternative sintering methods are known for certain applications or for production of certain components. For example, in the case of so-called ultrafast sintering, electric voltages are applied to a substrate to be sintered. For this purpose, for example, two strips of carbon fibers may be placed on a sintering sample and then an electric voltage applied, as a result of which temperatures of up to 3000° C. may arise in the sintering sample. However, the contacting of each individual sintering sample requires a significant outlay. Moreover, the sintering sample must generally be protected during sintering by virtue of the fact that it is surrounded with a protective gas atmosphere. In the case of an alternative approach which is also referred to as flash sintering, in the case of a certain sintering temperature, an electric field is additionally applied to a sintering sample. As a result of this, a sintering time may be limited to a few minutes. However, higher energy consumption and additional modules are generally required to apply the electric field.

In contrast to the approaches described above, the sintering processes used in the case of the manufacturing method proposed herein may be performed substantially in ambient conditions. The substrate with the layer applied thereon only has to be brought to an elevated sintering temperature without, however, a special gas atmosphere having to be generated around the substrate. In particular, no protective gas has to be provided, for example, in the form of a noble gas or inert gas. A generation of an electric field, in particular an electrical contacting of the layer to be sintered in order to apply an electrical voltage may be omitted. Overall, as a result of this, the method may be carried out with a very small equipment configuration, low energy requirement and/or in a short time.

According to one embodiment, the substrate is cooled to the ambient temperature after sintering and prior to the printing of each of the further layers. The ambient temperature may typically lie between 10° C. and 30° C., preferably between 15° C. and 25° C. For this purpose, the substrate may be removed from the furnace and then, as a result of its large surface, cool comparatively quickly, i.e. in particular within a few minutes, to the ambient temperature. The printing process may thus be carried out without the need for special precautions, for example, to heat or cool the substrate.

According to one concrete configuration, initially an entire layer of ceramic material is accumulated on the surface of the substrate. For this purpose, the first layer and, preferably, one or more of the further layers is/are printed directly adjoining the first layer with an ink which has particles of ceramic material. In other words, a layer stack of preferably several thin layers is generated by printing ink with ceramic nano-particles, wherein each of the thin layers is sintered prior to printing of the subsequent layer. Overall, as a result of this, a ceramic layer may be generated, the layer thickness of which is composed of the individual thin layers. This ceramic layer may serve as a solid body electrolyte layer within a component to be formed, in particular within a sensor or a fuel cell.

A further entire layer of electrically conductive material may subsequently then be applied onto the layer of ceramic material. For this purpose, one or preferably more of the further layers may be printed with an ink which comprises particles of a metallic and/or metal oxide material. In a similar manner to the ceramic layer, the electrically conductive entire layer may also be generated by a plurality of thin layers which are successively printed and sintered. The electrically conductive entire layer may serve to form one or more electrodes within the component to be formed.

According to a more specific configuration, a multi-layer entire stack may be formed from alternating at least two layer stacks with ceramic material and at least two layer stacks with metallic material. Each of the layer stacks with ceramic material is formed by printing the first layer and/or one or more of the further layers directly adjacent to one another with an ink which comprises particles of a ceramic material. Each of the layer stacks with metallic material is formed by printing on one or more of the further layers directly adjacent to one another with an ink which comprises particles of a metallic and/or a metal oxide material.

In other words, an electrical component may be formed in that several layer stacks are mounted on top of one another to form an entire stack. Each individual layer stack may be composed of a single layer or preferably several layers, wherein the layers of a layer stack are formed in each case with the same ink. Here, at least two different types of layer stacks are generated and stacked alternately on top of one another. A first type of layer stack is generated with ink with ceramic particles and is therefore referred to as a layer stack with ceramic material, whereas a second type of layer stack with ink with metallic and/or metal oxide particles and is therefore referred to as a layer stack with metallic material. The layer stack with metallic material may form an electrode or a part of an electrode. In each case a layer stack with ceramic material which may form a solid body electrolyte layer is, in the interim, mounted between adjacent layer stacks with metallic material.

As a result of the alternating formation of layer stacks with ceramic material and layer stacks with metallic material, overall an entire stack may be formed, in the case of which one or more electrode layers are separated from one another by intermediate solid body electrolyte layers.

It was observed that such a multi-layer entire stack enables various advantages. For example, it was identified that a sensor formed with the various alternately arranged layer stacks may measure more sensitively and/or precisely, the greater the number of boundary layers adjoining one another are contained therein between an electrode layer and a solid body electrolyte layer. Moreover, it was furthermore observed that material phases which may act advantageously may be locally formed on boundary layers between an electrode layer and a solid body electrolyte layer adjoining each other. For example, such material phases may give the sensor increased mechanical and/or chemical stability.

In particular, at least one of the further layers may be printed in the form of a pattern which maps two electrodes which are laterally spaced apart from one another. In other words, one or more of the printed layers may not be printed as a continuous or full-surface layer, but rather as at least two partial layers, wherein the two partial layers are laterally spaced apart from one another and each partial layer with its contour forms in each case one of two or more electrodes. The two electrodes may thus be formed spatially separated from one another on the ceramic layer which lies thereunder and correspondingly connected to one another only via the ceramic layer and otherwise electrically insulated from one another. In so far as the ceramic layer serves as a solid body electrolyte layer, when an electric voltage is applied to the two electrodes, an electric current which arises may be dependent on the properties of this solid body electrolyte layer. The properties of the solid body electrolyte layer may in turn be dependent on ambient conditions such as in particular a surrounding gas atmosphere so that the entire structural element may act as a gas sensor.

The electrical component according to one embodiment of the second aspect of the invention may be manufactured in particular with the aid of the method presented herein. In the case of the component, several layers of metallic, metal oxide and/or ceramic material are located on a substrate. The layers are generated in this case by printing an ink of binder and embedded particles and subsequent sintering of the ink at over 300° C., preferably at least 500° C. In particular, each of the layers has been sintered individually after printing. As a result of such manufacture, the entire layer formed from the several layers has typical microscopic and/or macroscopic properties, in particular a typical microscopic and/or macroscopic structure. It is apparent in particular in the entire layer that particles are sintered together in each of the individual layers. The stack-like structure of the several layers which were printed successively and respectively sintered is also apparent in the entire layer which is ultimately produced and may serve as a typical feature for the fact that the electrical component was manufactured according to one embodiment of the method described herein. For example, a porous structure which is typically for the manufacturing process is exhibited. This generally forms a basis for outstanding functionality of the layer. An elevated surface or reaction surface at what is known as the three phase boundary (TPB) is typically produced by the porous structure. Moreover, sintering necks of the nano-particles which are sintered together are usually apparent, which is typical for this manufacturing process.

It should be pointed out that possible features and advantages of embodiments of the invention are described herein partially with reference to a manufacturing method configured according to the invention and partially with reference to an electrical component according to the invention. A person skilled in the art will recognize that the features described for individual embodiments may be suitably transferred in an analogous manner to other embodiments, may be adapted and/or may be exchanged in order to arrive at further embodiments of the invention and potentially synergistic effects.

### BRIEF DESCRIPTION OF THE DRAWINGS

Advantageous embodiments of the invention will be explained further below with reference to the enclosed drawings, wherein neither the drawings nor the explanations should be interpreted as restricting the invention in any manner.

FIGS. 1(a)-(d) show, in side views, a sequence of method steps of a manufacturing method according to one embodiment of the present invention.

FIG. 2 shows a plan view of an electrical component according to one embodiment of the present invention.

FIG. 3 shows a sectional view through an electrical component with a multilayer structure according to one embodiment of the present invention.

The figures are only schematic and not true-to-scale. Identical reference signs designate identical features or features with a same effect in the various drawings.

### DESCRIPTION OF ADVANTAGEOUS EMBODIMENTS

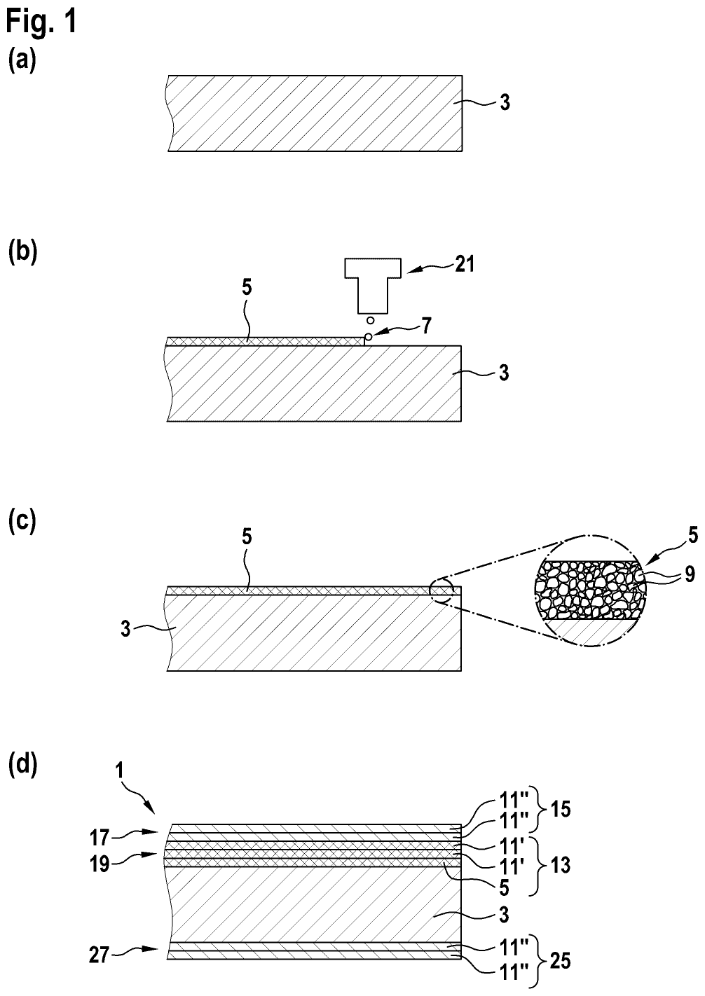

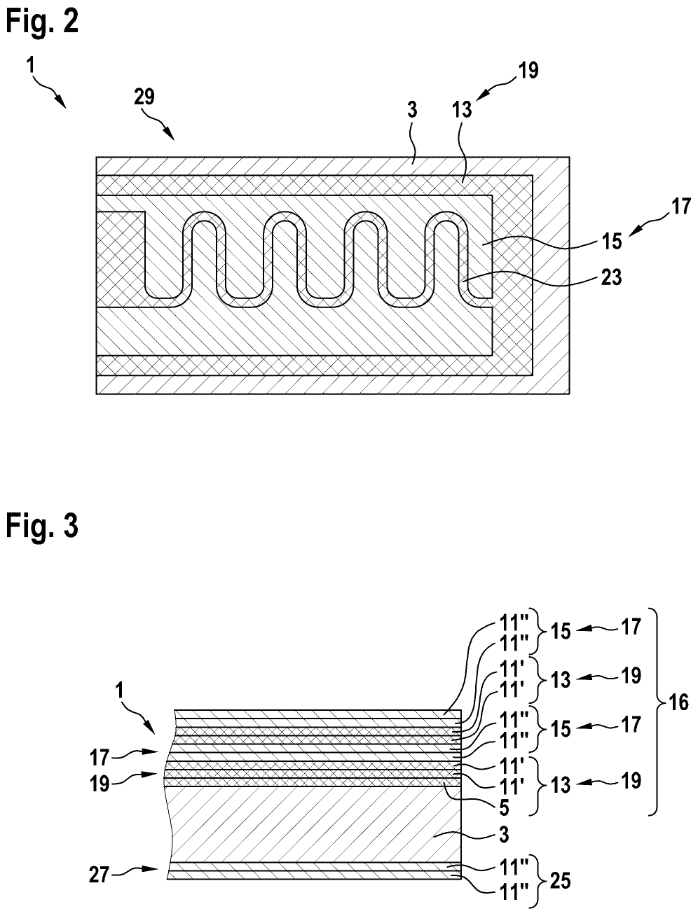

FIG. 1 shows, in side views, a sequence of method steps for manufacturing an electrical component 1. FIG. 2 shows a plan view of a finished component 1 in the form of a gas sensor 29.

As illustrated in FIG. 1(a), a substrate 3 is initially provided. For example, a disc or a wafer of aluminum oxide or silicon may serve as substrate 3.

A first layer 5 of ink 7 is printed onto the substrate 3, as represented in FIG. 1(b), with the aid of an inkjet head 21. In this case, the ink 7 has particles of metallic, metal oxide or ceramic material which are embedded into a binder.

Once the first layer 5 has been printed, the substrate including this first layer 5 undergoes a sintering process. In the case of these, the substrate 3 including the layer 5 of ink 7 is sintered for up to five minutes at 600° C., in some cases at up to 900° C. As schematically illustrated in the enlarged cut-out in FIG. 1(c), in this case the particles 9 contained in the layer 5 come into direct contact with one another once the binder has been able to escape the ink 7. Adjacent particles 9 may enter into firmly bonded connections with one another during sintering as a result of diffusion processes and/or local fusing which occur in this case and/or form what are known as sintering necks.

After sintering, the substrate 3 is removed from the furnace and may cool to the ambient temperature.

Subsequently, several further layers 11 of ink 7 are printed successively onto the substrate 3. After each individual printing process, the respectively printed layer 11 is sintered, preferably at a temperature adapted for the printed material of, for example, 600° C. or more, in the case of ceramic materials typically even 900° C. or more.

As illustrated in FIG. 1(d) and FIG. 2, as a result of this, a layer stack 13 with ceramic material which forms a solid body electrolyte layer 19 may be generated on an upper side of the substrate 3. The layer stack 13 with ceramic material may be generated by printing an ink 7 with ceramic particles 9 to form one or more adjoining layers 11′. A further layer stack 15 with metallic material is formed above this solid body electrolyte layer 19, as a result of which one or more electrodes 17 is/are generated. The shift stack 15 with metallic material may be generated by printing an ink 7 with metallic or metal oxide particles 9 to form one of more adjoining layers 11″.

In particular, two electrodes 17 may be formed laterally spaced apart from one another such that a gap 23 remains between these. If an electric voltage is applied to the two electrodes 17, an electrical current may only flow between the electrodes 17 when the solid body electrolyte layer 19 adjoining the electrodes 17 has a certain conductivity, in particular as a result of the conductance of ions. In other words, an electric direct voltage may be applied between the two printed electrodes, as a result of which an oxygen ion flow may flow in the solid electrolyte (heated, for example, to at least 400° C. (for YSZ)) and an electric current may flow in the outer current circuit electrically connected thereto. Since the ion conductivity of the solid body electrolyte layer 19 depends, among other things, on an ambient gas atmosphere, a concentration of gases in the surroundings may be concluded in this manner. Overall, the electrical component 1 may thus act as a gas sensor 29.

A further layer stack 25 with metallic material may additionally be formed on a rear side of the substrate 3 of the component 1, which layer stack 25 may act as a heating coil 27 so that the entire gas sensor 29 may where necessary be heated to a specified temperature.

FIG. 3 shows a sectional view through an electrical component 1 formed as a gas sensor, in the case of which two layer stacks 13 with ceramic material and two layer stacks 15 with metallic material were deposited in an alternating manner on top of one another and as a result of this a multi-layer entire stack 16 was formed. Each of the layer stacks 13 with ceramic material comprises in this case at least one or preferably several layers 11′ which were generated in each case by printing an ink 7 with ceramic material and subsequent sintering and which jointly form a solid body electrolyte layer 19. Each of the layer stacks 15 with metallic material comprises at least one or preferably several layers 11″ which were generated in each case by printing an ink 7 with metallic or metal oxide material and subsequent sintering and which jointly form an electrode 17 or a part of an electrode 17.

It should be pointed out that in the figure each of the layer stacks 13, 15 has only two layers 11′ or 11″, but that significantly more such layers may be present in the case of practical applications. Moreover, in the case of practical applications, more than two layer stacks 13 with ceramic material may be provided for the formation of the solid body electrolyte layer 19 and/or more than two layer stacks 15 with metallic material may be provided for the formation of the electrodes 17.

Each of the layer stacks 15 may be formed in a structured manner in this case such that two electrodes 17 laterally spaced apart from one another (as illustrated in FIG. 2) are generated, wherein the two electrodes 17 in the various layer stacks 15 may have the same contours or contours which differ from one another, but preferably at least partially overlap one another in plan view. The layer stacks 13 running between the adjacent layer stacks 15 for the formation of the solid body electrolyte layer 19 may be formed over the full surface in particular since they are generally porous and gas may thus flow through these solid body electrolyte layers 19. Alternatively, the layer stacks 13 for the formation of the solid body electrolyte layer 19 may also be structured, in particular with a geometry or contour analogous to the geometry of the layer stacks 15 which form the electrodes 17.

3-phase boundaries (TPB) may form in each case at boundaries between adjoining layer stacks 13 of the solid body electrolyte layer 19 on one hand and layer stacks 15 of the electrodes 17 on the other hand, wherein, as a result of a plurality of such boundaries inside the entire stack 16, a sensitivity of the overall formed sensor-like electrical component 1 may be improved.

Accompanying thoughts as to the approach explained herein as well as possible configurations of the method presented herein or of the resultant component will be explained again with a slightly different word selection:

Industrially, electrochemical sensors have hitherto usually been manufactured using the screen printing method or partially with PVD methods. Both methods consume a lot of material in comparison with inkjet printing since in this case a mask must also generally be sputtered or printed. The known industrial manufacturing methods PVD and screen printing thus consume a lot of material and make it necessary to acquire masks. The known methods for manufacturing electrochemical sensors are therefore not particularly flexible. In this case, rapid prototyping or rapid adjustments to the manufacturing technology is barely possible or only with great difficulty.

In the case of the approach described herein, inter alia, inkjet printing, sometimes also referred to as the inkjet method, is used. Since the inkjet method is a mask-less method, the high material consumption which is commonplace in the case of conventional methods is prevented. Moreover, the inkjet printing method is a purely digital method. Additional production steps or procurement such as a mask, as normally have to be used in the case of PVD and screen printing systems, are thus dispensed with. The known process solutions require further equipment, have a high degree of energy consumption or are restricted to the sintering of impervious materials (“green body”) or do not describe the process of the individually sintered (metallic and ceramic) layers. Moreover, no sintering may occur at ambient temperatures and rapid manufacture of the overall system may not be performed at times with the known methods.

The process presented here offers a significant improvement in inkjet printing also in so far as the overall process time may be significantly reduced and the energy consumption for sintering processes is lower than the previously used processes. The process described here additionally offers the promise of being usable on metallic and ceramic materials as well as good control in terms of layer thickness and morphology. It was possible for the first time to print several individual layers which have led in each case with the aid of a thermal “rapid” sintering step (thermal rapid sintering) to a functional electrochemical solid electrolyte sensor. This process leads to morphologies which are advantageous for the sensor function.

The approach described herein represents a rapid process route for the manufacture in particular of electrochemical solid electrolyte sensor and/or SOFCs by means of inkjet methods, using layer-by-layer printing of functional materials in combination with a rapid sintering process for the manufacture of electrochemical solid electrolyte components. It relates to a general process for a manufacture of thin metallic, ceramic and/or metal oxide layers, wherein individual nano-particle suspension layers are applied layer-by-layer and sintered with a rapid thermal sintering process (thermal rapid sintering) in ambient conditions. The process makes it possible to manufacture ceramic and metallic layers in an energy-efficient, simple, quick and easily controllable manner in terms of morphology (porous or impervious, layer thickness and homogeneity of the layers). The layers manufactured may be used in the field of electrochemical (high-temperature) solid electrolyte components (e.g. sensors and SOFCs).

The electrochemical (high-temperature) solid electrolyte components (e.g. sensors and SOFCs) cited here consist of in particular the following single layer structures:
Electrolyte: a ceramic layer
Electrode: a metallic/(metal oxide) layer
Heating coil: a metallic layer

It was already possible to manufacture some functional solid electrolyte-oxygen sensors. In short characterization tests and in a 2000 h long-term test, it was possible to achieve good results with the manufactured sensors.

The rapid process route for the manufacture of electrochemical high-temperature solid electrolyte sensors by means of inkjet methods should both shorten the production time and also reduce the energy consumption for the manufacture of such layers. Moreover, in the case of the presented process, a drying or compression step may generally be entirely dispensed with (in contrast to other sintering methods). A further point is the process time: As a result of the layer-by-layer structure in combination with rapid sintering, the process time is significantly shortened in comparison with normal methods. In this case, it was even possible to significantly improve the quality (in terms of porosity, electrochemical properties and long-term stability) of the layers.

Al₂O₃ is used here as substrate material. In principle, however, other temperature-stable materials could also be used, such as, for example, silicon wafer. Using metallic or ceramic nano-particle suspensions or nano-particle inks, individual layers are printed with a suitable print point density and after each of these layers sintered at material-specific temperatures for less than 15 min (thermal rapid sintering). This layer-by-layer structure enables both good control of the thickness of the layer and control of the morphology.

With the aid of the process route developed here, it becomes possible to generate porous structures, as may be advantageous for electrochemical sensors or SOFCs, or also dense structures, as are advantageous for the production of heating coils, in a short period of time. The rapid thermal sintering process is correspondingly adapted to the ultimate application or function of the layers. For example, the YSZ covering layer should be relatively porous, a YSZ electrolyte in the case of fuel cells should tend to be impervious and the YSZ electrolyte for SOFCs or sensors should tend to be porous.

Electrochemical solid electrolyte sensors which have long-term stability of more than 1000 h and enable a response time of less than 4 s (in some cases even in the range of one second) at pressures of 1×10⁻⁴ mbar may be produced with this process route.

An exemplary embodiment of a manufacturing method is described below:

A specified structure is filled entirely with nano-particle ink. A suitable self-generated print pattern with defined print point density is selected for this. These settings are, however, strongly dependent on the print head, ink, desired structure, etc. The duration of the printing is dependent on the printer system and the number of sensors to be manufactured.

A material-specific sintering process is selected:
a) For metallic layers, here e.g. platinum. Initially, Pt layers are printed as a “support layer” and these are sintered at 600° C. (or in some cases up to 900° C., as a result of which improved adhesion between platinum layer and electrolyte or substrate may be achieved, which may be explained by a quasi burning-in). This layer is necessary in so far as the following printed layers meet the requirements in terms of print image and electrical conductivity. The printed layers (normally 1-3 per step) are put at 600° C., i.e. in many cases at the target temperature, directly into the furnace, sintered for up to 10 minutes, removed at 600° C. and cooled at room temperature. As a result of this, the samples may be printed again after only a few minutes (max. 5 min). This process is repeated until the desired layer thickness or the desired electrical resistance is reached.
b) For ceramic layers, here e.g. YSZ. The substrates are printed with the ceramic ink and put at 600° C. into the furnace. The heating rate is selected at its maximum (e.g. 1600° C./h) so that the printed layers reach the material-specific target temperature of 950° C. (for YSZ) as fast as possible. The layers are sintered for up to 15 minutes and removed after an furnace-internal cooling process (max. 15 min) at 600° C. and cooled further at room temperature. As a result of this, the samples may be printed again after only a few minutes (max. 5.min). This process is repeated until the desired layer thickness is reached.

The oxygen sensors manufactured with the presented process currently consist of heating coil (platinum, 5-15 layers), electrode (platinum, 5-10 layers) and electrolyte (YSZ, 5-10 layers). A maximum printing time totaling 8h 45 min may be estimated as the process time in the case of a total number of 15 layers with in each case approx. 35 min. In principle, the manufacture of solid electrolyte sensors (FES) may probably be realized in a total of 12 h with the presented method.

In summary, one core feature of the invention may be seen in the process route, with which for the first time sensors with a sufficient sensor signal and temporal resolution for vacuum application may be produced. The complete process was newly developed and in a first step is configured for the production of electrochemical solid electrolyte sensors. A further core feature is the simple and accelerated manufacturing method by which the printing of the individual layers and the accelerated sintering step (thermal rapid sintering) are produced. A key aspect of the developed process is the method of layer-by-layer printing with a suitable point density in combination with the subsequent rapid sintering process for the manufacture of e.g. solid electrolyte sensors. The layer-by-layer printing process makes it possible to apply the functional materials (here YSZ and Pt) with good layer thickness control. Combined with the rapid sintering process, it is made possible to manufacture porous, even layers of the printed materials in a short period of time.

It should finally be pointed out that terms such as “having”, “comprising”, etc. do not exclude other elements or steps and terms such as “a” or “one” do not rule out a plurality. It should furthermore be pointed out that features or steps which have been described with reference to one of the above exemplary embodiments may also be used in combination with other features or steps of other exemplary embodiments described above. Reference signs in the claims should not be regarded as restrictive.

### LIST OF REFERENCE SIGNS

1 Electrical component
3 Substrate
5 First layer
7 Ink
9 Particle
11 Further layer
11′ Further layer generated with ink with ceramic particles
11″ Further layer generated with ink with metallic particles
13 Layer stack with ceramic material
15 Layer stack with metallic material
16 Entire stack
17 Electrode
19 Solid body electrolyte layer
21 Inkjet head
23 Gap
25 Layer stack with metallic material
27 Heating coil
29 Gas sensor

1-15. (canceled)

16. A method for manufacturing an electrical component, comprising at least the following steps:
(a) providing a substrate,
(b) printing a first layer of an ink onto the substrate, the ink comprising a flowable binder and a plurality of particles of at least one of a metallic, metal oxide and ceramic material embedded in the binder,
(c) sintering the substrate including the first layer of ink at a temperature above 300° C. for a time in a range of 1 min to 1 h,
(d) printing a further layer of an ink onto the substrate, the ink comprising a flowable binder and a plurality of particles of at least one of a metallic and ceramic material embedded in the binder,
(e) sintering the substrate including the further layer of ink at a temperature above 300° C. for a time in a range from 1 min to 1 h,
wherein the steps (d) and (e) are repeated with several repetitions.

17. The method as claimed in claim 16, wherein, in the case of the repetitions, the substrate is sintered at least once at a temperature above 500° C.

18. The method as claimed in claim 16, wherein the duration of the sintering is shorter than 20 min in the case of at least one of the sintering steps, preferably in the case of all the sintering steps.

19. The method as claimed in claim 16, wherein at least one of the following options applies:
the substrate consists of an inorganic material, in particular one of a ceramic material and a semi-conductor material, and
the consists of an electrically insulating material.

20. The method as claimed in claim 16, wherein the sintering is performed by introduction of the substrate into a furnace preheated to at least 300° C. immediately after the printing of the respective layer, in particular without at least one of preceding drying and compression of the printed layer.

21. The method as claimed in claim 16, wherein the sintering is performed at least one of without the substrate being surrounded by a protective gas atmosphere and without an electric voltage being applied to the substrate.

22. The method as claimed in claim 16, wherein the particles in the ink are nano-particles.

23. The method as claimed in claim 16, wherein at least one of the first and the further layers are printed in such a manner that they have a layer thickness of between 5 μm and 60 μm after printing and prior to sintering.

24. The method as claimed in claim 16, wherein the substrate is cooled to the ambient temperature prior to the printing of each of the further layers.

25. The method as claimed in claim 16, wherein the first layer and, optionally, at least one of the further layers are printed directly adjacent to the first layer with an ink which comprises particles of a ceramic material.

26. The method as claimed in claim 25, wherein at least one of the further layers is printed with an ink which comprises particles of at least one of a metallic and a metal oxide material.

27. The method as claimed in claim 26, wherein a multi-layer entire stack of at least two alternating layer stacks with ceramic material and at least two layer stacks with metallic material is formed, wherein each of the layer stacks with ceramic material is formed by printing at least one of the first layer and at least one of the further layers directly adjacent to one another with an ink which comprises particles of a ceramic material and wherein each of the layer stacks with metallic material is formed by printing on at least one of the further layers directly adjacent to one another with an ink which comprises particles of at least one of a metallic and a metal oxide material.

28. The method as claimed in claim 16, wherein at least one of the further layers is printed in the form of a pattern which maps two electrodes which are laterally spaced apart from one another.

29. An electrical component, in particular one of a sensor and a solid oxide fuel cell, comprising:
a substrate, and
a plurality of layers of at least one of a metallic, metal oxide and ceramic material applied to the substrate,
wherein each of the layers is formed by printing an ink comprising a flowable binder and a plurality of particles of at least one of a metallic, metal oxide and ceramic material embedded in the binder, and subsequently sintering the ink at above 300° C.

30. The electrical component as claimed in claim 29, wherein the component is manufactured by
(a) providing a substrate,
(b) printing a first layer of an ink onto the substrate, the ink comprising a flowable binder and a plurality of particles of at least one of a metallic, metal oxide and ceramic material embedded in the binder,
(c) sintering the substrate including the first layer of ink at a temperature above 300° C. for a time in a range of 1 min to 1 h,
(d) printing a further layer of an ink onto the substrate, the ink comprising a flowable binder and a plurality of particles of at least one of a metallic and ceramic material embedded in the binder,
(e) sintering the substrate including the further layer of ink at a temperature above 300° C. for a time in a range from 1 min to 1 h,
wherein the steps (d) and (e) are repeated with several repetitions.
